(19) United States
(12) Patent Application Publication
(10) Pub. No.: US 2024/0219869 A1
(43) Pub. Date: Jul. 4, 2024

(54) DYNAMIC DECOUPLING CONTROL METHOD FOR MULTI-DEGREE-OF-FREEDOM PRECISION MOTION STAGE

(71) Applicant: Harbin Institute of Technology, Harbin (CN)

(72) Inventors: Fazhi SONG, Harbin (CN); Yang LIU, Harbin (CN); Kaixin LIU, Harbin (CN)

(73) Assignee: Harbin Institute of Technology, Harbin (CN)

(21) Appl. No.: 18/353,900

(22) Filed: Jul. 18, 2023

(30) Foreign Application Priority Data
Dec. 21, 2022 (CN) 202211651456.5

(51) Int. Cl. G05B 13/02; G05B 19/042

(52) U.S. Cl. CPC G05B 13/025; G05B 19/0426

(57) ABSTRACT

A dynamic decoupling control method for a multi-degree-of-freedom precision comprises defining a dynamic decoupling controller and parameterizing elements in the form of a finite impulse response (FIR) filter, applying a nominal decoupling control method to measure an actual position signal of an actual system and an output of a nominal decoupling controller, calculating a virtual control quantity, and optimizing an indicator function to obtain an estimated value of a coefficient to be optimized of the dynamic decoupling controller. Decoupling at medium and high frequency bands can be effectively realized with improved accuracy of decoupling, and an algorithm flow is simplified. The method is prone to engineering implementation.

### CROSS-REFERENCE TO RELATED APPLICATIONS

This application claims priority to Chinese Patent Application No. 202211651456.5 with a filing date of Dec. 21, 2022. The content of the aforementioned application, including any intervening amendments thereto, is incorporated herein by reference.

### TECHNICAL FIELD

The present disclosure relates to a decoupling control method for a precision motion stage, and in particular to a dynamic decoupling control method for a multi-degree-of-freedom precision motion stage, and belongs to the field of control of multi-degree-of-freedom motion systems.

### BACKGROUND

A multi-degree-of-freedom precision motion stage is a typical multi-degree-of-freedom motion system and has the characteristics of complex structure and high control difficulty. When applied to a lithography machine, the motion performance of the multi-degree-of-freedom precision motion stage directly determines the yield and quality of manufactured chips. Taking a 28 nm immersion type lithography machine in China for example, it is required to meet a nano-level linear motion precision and a microradian-level rotational motion precision. To meet so stringent requirements, a control algorithm used must be intensively studied, in addition to using devices such as a high-performance motor and a high-precision sensor.

For a precision motion stage in a lithography machine, its requirement for multi-degree-of-freedom motion brings about a particular problem. Compared with a single-degree-of-freedom motion system, an interference between degrees of freedom in a multi-degree-of-freedom motion system is the most important factor influencing the motion performance. Generally, existing control strategies for a multi-degree-of-freedom motion system are nominal decoupling control methods, in which a nominal decoupling controller is obtained by calculation based on a nominal model such that a multi-degree-of-freedom controlled object is transformed into a plurality of single-degree-of-freedom controlled objects. However, the nominal decoupling controller obtained in such a way cannot completely decouple the system. Especially, at medium and high frequency bands, a comparatively obvious interference may be residual, thus seriously affecting the final motion precision. To improve the motion precision, the accuracy of decoupling needs to be improved as much as possible. In view of this, the present disclosure involves studying a dynamic decoupling method to solve the problem of incomplete decoupling by a conventional nominal decoupling control method.

### SUMMARY OF PRESENT INVENTION

To solve the shortcomings in the prior art, the present disclosure provides a dynamic decoupling control method for a multi-degree-of-freedom precision motion stage, which can effectively realize decoupling at medium and high frequency bands, improve the accuracy of decoupling, and simplify an algorithm flow, and is prone to engineering implementation.

To achieve the above objective, the present disclosure adopts the following technical solution: a dynamic decoupling control method for a multi-degree-of-freedom precision motion stage including the following steps:
defining a dynamic decoupling controller K(z):

$$K ( z ) = [ \begin{matrix}{K}_{11} ( z ) & {K}_{12} ( z ) & … & {K}_{1 n} ( z ) \\ {K}_{21} ( z ) & {K}_{22} ( z ) & … & {K}_{2 n} ( z ) \\ ⋮ & ⋮ & ⋱ & ⋮ \\ {K}_{n 1} ( z ) & {K}_{n 2} ( z ) & … & {K}_{nn} ( z )\end{matrix} ]$$

where z represents a time shift-forward operator, and for a discrete signal x(t), zx(t)=x(t+1); t represents a sampling time; and n represents the number of degrees of freedom of a motion stage;
parameterizing elements in the dynamic decoupling controller in the form of a finite impulse response (FIR) filter:

$${K}_{ij} ( z ) = {θ}_{ij , 0} + {θ}_{ij , 1} {z}^{- 1} + … + {θ}_{ij , m} {z}^{- m} = Ψ {θ}_{ij}$$

where m represents an order of the dynamic decoupling controller; Ψ=[1,z⁻¹, . . . , z^{-m}] is a basis function; θᵢⱼ=[θ_{ij,0},θ_{ij,1}, . . . , θ_{ij,m}]^{T}ΣR^{m+1} is a coefficient to be optimized; and R represents a real number field;
applying a nominal decoupling control method to measure an actual position signal y=[y₁,y₂, . . . , yₙ]^{T} of an actual system and an output d=[d₁,d₂, . . . , dₙ]^{T} of a nominal decoupling controller, and calculating a virtual control quantity ũ:

$$\tilde{u} ( t ) = {M}^{- 1} Ly = {[ {\tilde{u}}_{1} , {\tilde{u}}_{2} , … , {\tilde{u}}_{n} ]}^{T}$$

where M represents an expected diagonal model, and L represents a filter;
applying the virtual control quantity ū to the dynamic decoupling controller K(z), guaranteeing that an output from the dynamic decoupling controller is equal to a measured output d from the nominal decoupling controller, and enabling the dynamic decoupling controller K(z) to decouple the actual system in the form of the expected diagonal model M, wherein the parameters of the dynamic decoupling controller is adjusted to satisfy d=K(z)/ū as much as possible;
defining an indicator function:

$$J = {\sum }_{t = 1}^{N} {\sum }_{i = 1}^{n} {( {d}_{i} ( t ) - {\sum }_{j = 1}^{n} {\overline{u}}_{j} ( t ) {θ}_{ij} )}^{2}$$

where N represents the number of sampling points, and dᵢ represents the i-th element in the output from the nominal decoupling controller, ūⱼ(t) represents an information vector, ūⱼ(t)=Ψũⱼ(t)=[ũⱼ(t), ũⱼ(t−1), . . . , ũⱼ(t−m)]∈R^{1x(m+1)}, and ũj represents the j-th element in the virtual control quantity; the indicator function is minimized to obtain an estimated value of the coefficient to be optimized of the dynamic decoupling controller; and the following parameters are defined in order to simplify the algorithm flow:

$$\begin{matrix}{D}_{i} = {[ {d}_{i} ( 1 ) , {d}_{i} ( 2 ) , … , {d}_{i} ( N ) ]}^{T} \\ {τ}_{i} = {[ {θ}_{i 1}^{T} , {θ}_{i 2}^{T} , … , {θ}_{i n}^{T} ]}^{T} \\ ϕ ( t ) = [ {\overline{u}}_{1} ( t ) , {\overline{u}}_{2} ( t ) , … , {\overline{u}}_{n} ( t ) ] \\ Φ = {[ φ {( 1 )}^{T} , φ {( 2 )}^{T} , … , φ {( N )}^{T} ]}^{T}\end{matrix}$$

decomposing an optimization problem of the indicator function into n optimization subproblems:

$$\begin{matrix}J = {\sum }_{t = 1}^{N} {\sum }_{i = 1}^{n} {( {d}_{i} ( t ) - {\sum }_{j = 1}^{n} {\overline{u}}_{j} ( t ) {θ}_{ij} )}^{2} \\ = {\sum }_{t = 1}^{N} {\sum }_{i = 1}^{n} {( {d}_{i} ( t ) - ϕ ( t ) {τ}_{i} )}^{2} \\ = {\sum }_{i = 1}^{n} {( {D}_{i} - Φ {τ}_{i} )}^{T} ( {D}_{i} - Φ {τ}_{i} ) \\ = {\sum }_{i = 1}^{n} {‖ {D}_{i} - Φ {τ}_{i} ‖}^{2}\end{matrix}$$

letting Jᵢ=∥Dᵢ−Φτᵢ∥² and minimizing Jᵢ,i=1, 2, . . . n to obtain an estimated value \hat{τ}ᵢ of parameter τᵢ:

$$\begin{matrix}{\hat{τ}}_{i} & {( {Φ}^{T} )}^{- 1} & {}^{T} {D}_{i}\end{matrix} = {[ {\hat{θ}}_{i 1}^{T} , {\hat{θ}}_{i 2}^{T} , … , {\hat{θ}}_{i n}^{T} ]}^{T}$$

thereby obtaining an estimated value of \hat{θ}ᵢⱼ the coefficient θᵢⱼ to be optimized of element Kᵢⱼ(z) in the i-th row and the j-th column in the dynamic decoupling controller K(z), thus realizing dynamic decoupling control.

Compared with the prior art, the present disclosure has the following beneficial effects: the dynamic decoupling controller used in the dynamic decoupling control method proposed in the present disclosure is in the form of the FIR filter so that decoupling at medium and high frequency bands can be effectively realized, thus improving the accuracy of decoupling. The problem of incomplete decoupling caused by a conventional nominal decoupling control method is addressed, and there is no need to know an accurate model of an object, avoiding a complex identification process. The design can be completed only by using an actual position signal that can be measured and output data of the nominal decoupling controller. The method is prone to engineering implementation. The influence of the interference between the degrees of freedom in the system is reduced and the motion performance is improved.

### BRIEF DESCRIPTION OF THE DRAWINGS

FIG. 1 is a system block diagram of a two-degree-of-freedom motion stage according to an embodiment of the present disclosure;

FIG. 2 illustrates actual position signals at x and y degrees of freedom according to an embodiment of the present disclosure;

FIG. 3 illustrates an output signal of a nominal decoupling controller according to an embodiment of the present disclosure;

FIG. 4 illustrates a square signal according to an embodiment of the present disclosure;

FIG. 5 illustrates a system output when tracking a square signal at an x degree of freedom according to an embodiment of the present disclosure; and

FIG. 6 illustrates a system output when tracking a square signal at a y degree of freedom according to an embodiment of the present disclosure.

### DETAILED DESCRIPTION OF THE EMBODIMENTS

The technical solution of the present disclosure will be clearly and completely described below with reference to the accompanying drawings in the embodiments of the present disclosure. Apparently, the described embodiments are merely a part rather than all of the embodiments of the present disclosure. All other embodiments derived from the embodiments in the present disclosure by a person of ordinary skill in the art without creative efforts should fall within the protection scope of the present disclosure.

A dynamic decoupling control method for a multi-degree-of-freedom precision motion stage includes the following steps:
define a dynamic decoupling controller K(z):

$$K ( z ) = [ \begin{matrix}{K}_{11} ( z ) & {K}_{12} ( z ) & … & {K}_{1 n} ( z ) \\ {K}_{21} ( z ) & {K}_{22} ( z ) & … & {K}_{2 n} ( z ) \\ ⋮ & ⋮ & ⋱ & ⋮ \\ {K}_{n 1} ( z ) & {K}_{n 2} ( z ) & … & {K}_{nn} ( z )\end{matrix} ]$$

where z represents a time shift-forward operator, and for a discrete signal x(t), zx(t)=x(t+1); t represents a sampling time; and n represents the number of degrees of freedom of a motion stage;
parameterize elements in the dynamic decoupling controller in the form of a finite impulse response (FIR) filter:

$${K}_{ij} ( z ) = {θ}_{ij , 0} + {θ}_{ij , 1} {z}^{- 1} + … + {θ}_{ij , m} {z}^{- m} = Ψ {θ}_{ij}$$

where m represents an order of the dynamic decoupling controller; Ψ=[1, z⁻¹, . . . , z^{-m}] is a basis function; θᵢⱼ=[θ_{ij,0},θ_{ij,1}, . . . , θ_{ij,m}]^{T}∈R^{m+1} is a coefficient to be optimized; and R represents a real number field;
apply a nominal decoupling control method to measure an actual position signal y=[y₁,y₂, . . . , yₙ]^{T} of an actual system and an output d=[d₁, d₂, . . . , dₙ]^{T} of a nominal decoupling controller, and calculate a virtual control quantity ũ with the measured data:

$$\tilde{u} ( t ) = {M}^{- 1} Ly = {[ {\tilde{u}}_{1} , {\tilde{u}}_{2} , … , {\tilde{u}}_{n} ]}^{T}$$

where M represents an expected diagonal model, and L represents a filter;
the expected diagonal model M is in the following form:

$$M = [ \begin{matrix}{M}_{1} & & & \\ & {M}_{2} & & \\ & & ⋱ & \\ & & & {M}_{n}\end{matrix} ]$$

where a diagonal element Mᵢ represents an expected model of the i-th degree of freedom, in the following form:

$${M}_{i} = \frac{1}{{h}_{i} {s}^{2}} \cdot \frac{1}{{τ}_{i} + 1} , i = \{ 1 , 2 , … , n \}$$

where hᵢ represents an inertia coefficient for the i-th degree of freedom, and s represents a Laplace operator, and τᵢ represents a time constant of a time delay in the system, which may be approximate to 0 if a time delay in the system is tiny; and the filter L is in the following form:

$$L = \frac{1}{{( {k}_{s} s + 1 )}^{2}}$$

where kₛ represents a time constant, and generally, kₛ=0.01;
apply the virtual control quantity ũ to the dynamic decoupling controller K(z), guarantee that an output from the dynamic decoupling controller is equal to a measured output d from the nominal decoupling controller, and enable the dynamic decoupling controller K(z) to decouple the actual system in the form of the expected diagonal model M, wherein the parameters of the dynamic decoupling controller is adjusted to satisfy d=K(z)/ũ as much as possible;
define an indicator function:

$$J = {\sum }_{t = 1}^{N} {\sum }_{i = 1}^{n} {( {d}_{i} ( t ) - {\sum }_{j = 1}^{n} {\overline{u}}_{j} ( t ) {θ}_{ij} )}^{2}$$

where N represents the number of sampling points, and dᵢ represents the i-th element in the output from the nominal decoupling controller, ũⱼ(t) represents an information vector, ūⱼ(t)=Ψũⱼ(t)=[ũⱼ(t),ũⱼ(t−1), . . . , ũⱼ(t−m)]∈R^{1x(m+1)}, and ũⱼ represents the j-th element in the virtual control quantity; the indicator function is minimized to obtain an estimated value of the coefficient to be optimized of the dynamic decoupling controller, and the following parameters are defined in order to simplify the algorithm flow:

$${D}_{i} = {[ {d}_{i} ( 1 ) , {d}_{i} ( 2 ) , … , {d}_{i} ( N ) ]}^{T}$$

$${τ}_{i} = {[ {θ}_{i 1}^{T} , {θ}_{i 2}^{T} , … , {θ}_{i n}^{T} ]}^{T}$$

$$ϕ ( t ) = [ {\overline{u}}_{1} ( t ) , {\overline{u}}_{2} ( t ) , … , {\overline{u}}_{n} ( t ) ]$$

$$Φ = {[ φ {( 1 )}^{T} , φ {( 2 )}^{T} , … , φ {( N )}^{T} ]}^{T}$$

decompose an optimization problem of the indicator function into n optimization subproblems:

$$\begin{matrix}J = {\sum }_{t = 1}^{N} {\sum }_{i = 1}^{n} {( {d}_{i} ( t ) - {\sum }_{j = 1}^{n} {\overline{u}}_{j} ( t ) {θ}_{ij} )}^{2} \\ = {\sum }_{t = 1}^{N} {\sum }_{i = 1}^{n} {( {d}_{i} ( t ) - ϕ ( t ) {τ}_{i} )}^{2} \\ = {\sum }_{i = 1}^{n} {( {D}_{i} - Φ {τ}_{i} )}^{T} ( {D}_{i} - Φ {τ}_{i} ) \\ = {\sum }_{i = 1}^{n} {‖ {D}_{i} - Φ {τ}_{i} ‖}^{2}\end{matrix}$$

let Jᵢ=∥Dᵢ−Φτᵢ∥², minimize Jᵢ,i=1, 2, . . . n to obtain an estimated value of parameter τᵢ, where due to τᵢ=[θᵢ₁^{T},θᵢ₂^{T}, . . . , θᵢₙ^{T}]^{T}, the estimated value of the coefficient θᵢⱼ to be optimized can be obtained from the estimated value of the parameter τᵢ, and Jᵢ is minimized by using a method of least squares to obtain the estimated value \hat{τ}ᵢ of the parameter τᵢ:

$$\begin{matrix}{\hat{τ}}_{i} & {( {Φ}^{T} )}^{- 1} & {}^{T} {D}_{i}\end{matrix} = {[ {\hat{θ}}_{i 1}^{T} , {\hat{θ}}_{i 2}^{T} , … , {\hat{θ}}_{i n}^{T} ]}^{T}$$

thereby obtain an estimated value θᵢⱼ of the coefficient θᵢⱼ to be optimized of element Kᵢⱼ(z) in the i-th row and the j-th column in the dynamic decoupling controller K(z), thus realizing dynamic decoupling control.

### Example

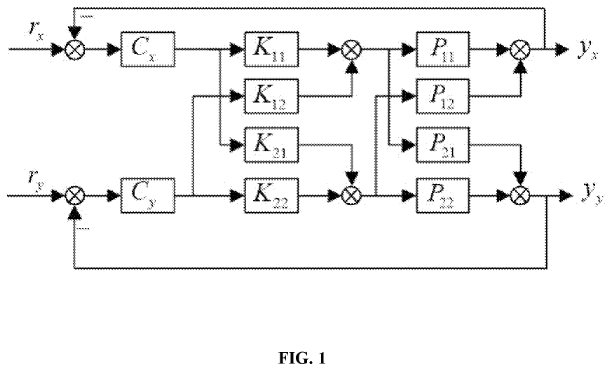

With reference to FIG. 1, assuming that a precision motion stage is a two-degree-of-freedom motion stage, dynamic properties of an actual system may be described by using a transfer function matrix:

$$P = [ \begin{matrix}\frac{0.1}{{s}^{2}} & \frac{0.5}{{s}^{2}} \\ \frac{0.05}{{s}^{2}} & - \frac{0.25}{{s}^{2}}\end{matrix} ] ,$$

and an expected diagonal model of the system has no time delay,

$$M ( s ) = [ \begin{matrix}\frac{0.1}{{s}^{2}} & 0 \\ 0 & \frac{0.05}{{s}^{2}}\end{matrix} ] ,$$

and a servo cycle of the control system is

$${T}_{s} = 200 μ s .$$

A dynamic decoupling controller K(z) is defined:

$$K ( z ) = [ \begin{matrix}{k}_{11} ( z ) & {k}_{12} ( z ) \\ {k}_{21} ( z ) & {k}_{22} ( z )\end{matrix} ] = [ \begin{matrix}{θ}_{11 , 0} + {θ}_{11 , 1} {z}^{- 1} & {θ}_{12 , 0} + {θ}_{12 , 1} {z}^{- 1} \\ {θ}_{21 , 0} + {θ}_{21 , 1} {z}^{- 1} & {θ}_{22 , 0} + {θ}_{22 , 1} {z}^{- 1}\end{matrix} ]$$

Each element in the dynamic decoupling controller is expressed as:

$${θ}_{11} = {[ \begin{matrix}{θ}_{11 , 0} & {θ}_{11 , 1}\end{matrix} ]}^{T} ,$$

$${θ}_{12} = {[ \begin{matrix}{θ}_{12 , 0} & {θ}_{12 , 1}\end{matrix} ]}^{T} ,$$

$${θ}_{21} = {[ \begin{matrix}{θ}_{21 , 0} & {θ}_{21 , 1}\end{matrix} ]}^{T} , and$$

$${θ}_{22} = {[ \begin{matrix}{θ}_{22 , 0} & {θ}_{22 , 1}\end{matrix} ]}^{T} .$$

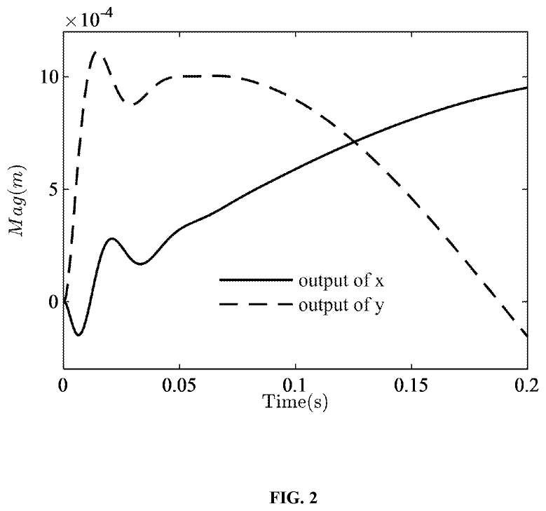

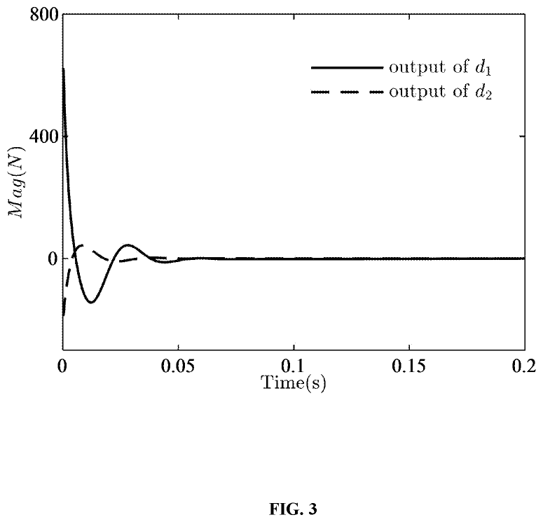

A nominal decoupling control method is applied to a measured actual position signal y of the actual system and an output d from a nominal decoupling controller, respectively as shown in FIG. 2 and FIG. 3, and then the time constant kₛ of a low-pass filter L is let to be 0.01. The measured actual position signal y is passed through the filter M⁻¹L, and a virtual control quantity ũ is calculated.

An indicator function to be optimized is as follows:

$$J = {J}_{1} + {J}_{2} = {‖ {D}_{1} - Φ {τ}_{1} ‖}^{2} + {‖ {D}_{2} - Φ {τ}_{2} ‖}^{2}$$

J₁=∥D₁−Φ_{τ1}∥² and J₂=∥D₂−Φ_{τ2}∥² are separately minimized by using the method of method of least squares, and resulting estimated values of parameters τ₁ and τ₂ are respectively as follows:

$${\hat{τ}}_{1} = {[ \begin{matrix}0.4792 & 0.02041 & 0.4913 & 0.008939\end{matrix} ]}^{T}$$

$${\hat{τ}}_{2} = {[ \begin{matrix}0.1059 & - 0.00584 & - 0.09729 & - 0.002764\end{matrix} ]}^{T}$$

Due to the parameters τ₁=[θ₁₁^{T},θ₁₂^{T}]^{T} and τ₂=[θ₂₁^{T},θ₂₂^{T}]^{T} the estimated value \hat{θ}ᵢⱼ of the coefficient to be optimized can be extracted from the estimated values of the parameters τ₁ and τ₂, thereby obtaining:

$${\hat{θ}}_{11} = {[ \begin{matrix}0.4792 & 0.0204\end{matrix} ]}^{T} ,$$

$${\hat{θ}}_{12} = {[ \begin{matrix}0.4912 & 0.008939\end{matrix} ]}^{T} ,$$

$${\hat{θ}}_{21} = {[ \begin{matrix}0.1059 & - 0.00584\end{matrix} ]}^{T} ,$$

$${\hat{θ}}_{22} = {[ \begin{matrix}- 0.09729 & - 0.002764\end{matrix} ]}^{T} ,$$

The estimated values are substituted into the form of the dynamic decoupling controller to obtain the final dynamic decoupling controller:

$${K}^{*} ( z ) = [ \begin{matrix}0.4792 + 0.02041 {z}^{- 1} & 0.4912 + 0.008939 {z}^{- 1} \\ 0.1059 - 0.00584 {z}^{- 1} & - 0.09729 - 0.002764 {z}^{- 1}\end{matrix} ] .$$

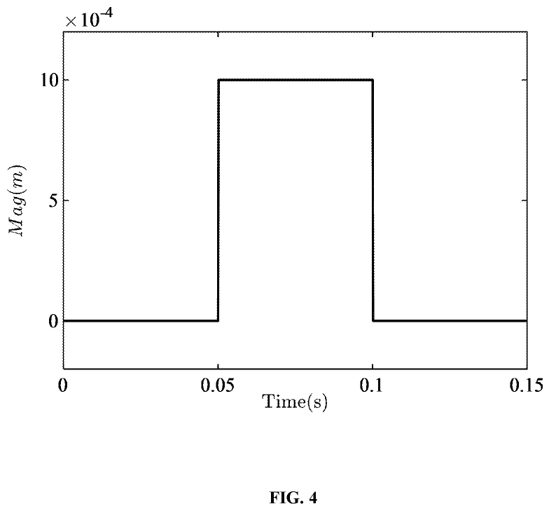

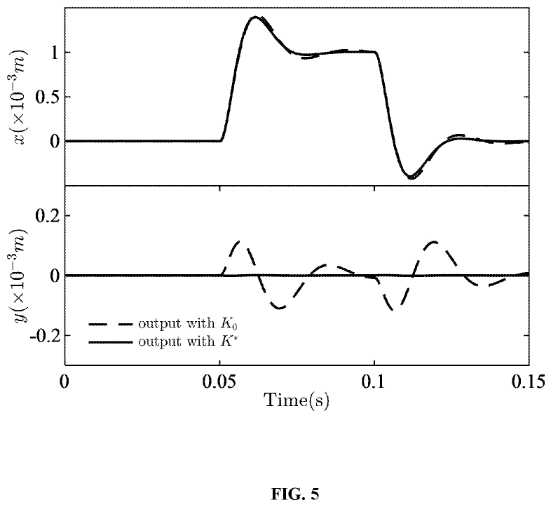

To verify the effectiveness of the dynamic decoupling control method, an experiment is conducted on the nominal decoupling controller K₀ and the dynamic decoupling controller K*(z) by using a square signal. The square signal used in the experiment is as shown in FIG. 4. Within a time of 0 s to 0.05 s, an amplitude of the square signal is 0. Within a time of 0.05 s to 0.1 s, the amplitude of the square signal is 0.001 m. Within a time of 0.1 s to 0.15 s, the amplitude of the square signal is 0. Firstly, the influence of motion at an x degree of freedom on a y degree of freedom is verified. In the experiment, a reference signal for the x degree of freedom is let to be a square signal, and a reference signal for the y degree of freedom is let to be 0. Theoretically, if the system is completely decoupled, the motion at the x degree of freedom will not affect the y degree of freedom. Therefore, the output of the y degree of freedom at this time should be kept to be 0. However, due to the presence of a decoupling error, the actual output of the y degree of freedom is not 0. It can be believed that ideal decoupling is realized as long as the output is below a certain degree. The actual system output is as shown in FIG. 5. As shown, the dotted line represents the output of the system S₁ when the nominal decoupling control method is used, and the full line represents the output of the system S₂ when the dynamic decoupling control method is used. It can be seen that within the time of 0.05 s to 0.1 s, when the reference signal for the x degree of freedom changes, an output of 10⁻⁴ order is generated on the y degree of freedom of S₁, indicating that the motion at the x degree of freedom has an influence on the y degree of freedom. This shows that the nominal decoupling control method cannot realize complete decoupling and is low in accuracy of decoupling. With reference to FIG. 3, it can also be seen that the system performance is greatly improved by using the dynamic decoupling control method proposed in the present disclosure. When motion occurs at the x degree of freedom, the output of the y degree of freedom of S₂ is at 10⁻⁶ order at most, which is significantly increased compared with the output of 10⁻⁴ order of S₁ and meets the requirement.

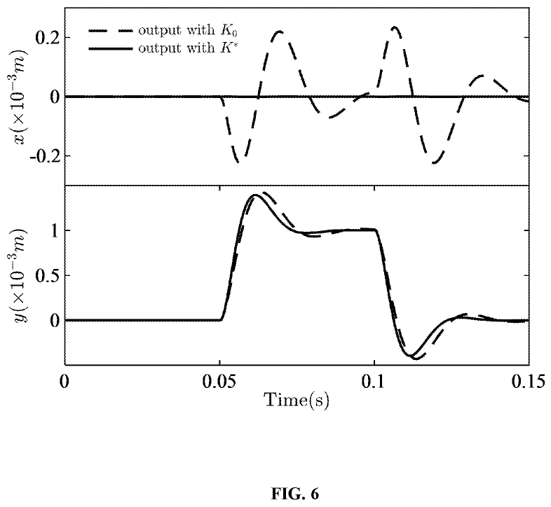

Then, the influence of motion at the y degree of freedom on the x degree of freedom is verified. In the experiment, the reference signal for the y degree of freedom is let to be a square signal, and the reference signal for the x degree of freedom is let to be 0. The experimental results are as shown in FIG. 6. As shown, the dotted line represents the output of the system S₁ when the nominal decoupling control method is used, and the full line represents the output of the system S₂ when the dynamic decoupling control method is used. It can be seen that when motion occurs at the y degree of freedom, an output of 2*10⁻⁴ order is also generated on the x degree of freedom of S₁, and the output of the y degree of freedom of S₂ is only at 3*10⁻⁷ order. The system accuracy is improved significantly, and the requirement of the indicator is met. It is verified that the dynamic decoupling control method proposed in the present disclosure is effective, and the accuracy of decoupling of the precision motion stage can be improved significantly, thus improving the motion performance of the system.

It is apparent for those skilled in the art that the present disclosure is not limited to details of the above exemplary embodiments, and that the present disclosure may be implemented in other particular forms without departing from the spirit or basic features of the present disclosure. The embodiments should be regarded as exemplary and non-limiting in every respect, and the scope of the present disclosure is defined by the appended claims rather than the above descriptions. Therefore, all changes falling within the meaning and scope of equivalent elements of the claims are intended to be included in the present disclosure. Any reference numerals in the claims should not be considered as limiting the claims involved.

It should be understood that although this description is made in accordance with the embodiments, not every embodiment includes only one independent technical solution. Such a description is merely for the sake of clarity, and those skilled in the art should take the description as a whole. The technical solutions in the embodiments can also be appropriately combined to form other embodiments which are comprehensible for those skilled in the art.

What is claimed is:

1. A dynamic decoupling control method for a multi-degree-of-freedom precision motion stage, comprising the following steps:
defining a dynamic decoupling controller K(z):
$$K ( z ) = [ \begin{matrix}{K}_{11} ( z ) & {K}_{12} ( z ) & … & {K}_{1 n} ( z ) \\ {K}_{21} ( z ) & {K}_{22} ( z ) & … & {K}_{2 n} ( z ) \\ ⋮ & ⋮ & ⋱ & ⋮ \\ {K}_{n 1} ( z ) & {K}_{n 2} ( z ) & … & {K}_{nn} ( z )\end{matrix} ]$$
wherein z represents a time shift-forward operator, and for a discrete signal x(t), zx(t)=x(t+1), t represents a sampling time, and n represents a number of degrees of freedom of a motion stage;
parameterizing elements in the dynamic decoupling controller in a form of a finite impulse response (FIR) filter:
$${K}_{ij} ( z ) = {θ}_{ij , 0} + {θ}_{ij , 1} {z}^{- 1} + … + {θ}_{ij , m} {z}^{- m} = Ψ {θ}_{ij}$$
wherein m represents an order of the dynamic decoupling controller; Ψ=[1, z⁻¹, . . . , z^{-m}] is a basis function; θᵢⱼ=[θ_{ij,0}, θ_{ij,1}, . . . , θ_{ij,m}]^{T}∈R^{m+1} is a coefficient to be optimized; and R represents a real number field;
applying a nominal decoupling control method to measure an actual position signal y=[y₁, y₂, . . . , yₙ]^{T} of an actual system and an output d=[d₁, d₂, . . . , dₙ]^{T} of a nominal decoupling controller, and calculating a virtual control quantity ũ:
$$\tilde{u} ( t ) = {M}^{- 1} Ly = {[ {\tilde{u}}_{1} , {\tilde{u}}_{2} , … {\tilde{u}}_{n} ]}^{T}$$
wherein M represents an expected diagonal model, and L represents a filter;
applying the virtual control quantity ũ to the dynamic decoupling controller K(z), guaranteeing that an output from the dynamic decoupling controller is equal to a measured output d from the nominal decoupling controller, and enabling the dynamic decoupling controller K(z) to decouple the actual system in the form of the expected diagonal model M;
defining an indicator function:
$$J = {\sum }_{t = 1}^{N} {\sum }_{i = 1}^{n} {( {d}_{i} ( t ) - {\sum }_{j = 1}^{n} {\overline{u}}_{j} ( t ) {θ}_{ij} )}^{2}$$
wherein N represents a number of sampling points, and dᵢ represents an i-th element in the output from the nominal decoupling controller, ūⱼ(t) represents an information vector, ūⱼ(t)=Ψũⱼ(t)=[ũⱼ(t),ũⱼ(t−1), . . . , ũⱼ(t−m)]∈R^{1x(m+1)}, and ũⱼ represents a j-th element in the virtual control quantity; the indicator function is minimized to obtain an estimated value of the coefficient to be optimized of the dynamic decoupling controller; and the following parameters are defined in order to simplify an algorithm flow:
$${D}_{i} = {[ {d}_{i} ( 1 ) , {d}_{i} ( 2 ) , … , {d}_{i} ( N ) ]}^{T}$$
$${τ}_{i} = {[ {θ}_{i 1}^{T} , {θ}_{i 2}^{T} , … , {θ}_{i n}^{T} ]}^{T}$$
$$ϕ ( t ) = [ {\overline{u}}_{1} ( t ) , {\overline{u}}_{2} ( t ) , … , {\overline{u}}_{n} ( t ) ]$$
$$Φ = {[ φ {( 1 )}^{T} , φ {( 2 )}^{T} , … , φ {( N )}^{T} ]}^{T}$$
decomposing an optimization problem of the indicator function into n optimization subproblems:
$$\begin{matrix}J = {\sum }_{t = 1}^{N} {\sum }_{i = 1}^{n} {( {d}_{i} ( t ) - {\sum }_{j = 1}^{n} {\overline{u}}_{j} ( t ) {θ}_{ij} )}^{2} \\ = {\sum }_{t = 1}^{N} {\sum }_{i = 1}^{n} {( {d}_{i} ( t ) - ϕ ( t ) {τ}_{i} )}^{2} \\ = {\sum }_{i = 1}^{n} {( {D}_{i} - Φ {τ}_{i} )}^{T} ( {D}_{i} - Φ {τ}_{i} ) \\ = {\sum }_{i = 1}^{n} {‖ {D}_{i} - Φ {τ}_{i} ‖}^{2}\end{matrix}$$
letting Jᵢ=∥Dᵢ−Φτᵢ∥², and minimizing Jᵢ, i=1, 2, . . . n to obtain an estimated value \hat{τ}ᵢ of parameter τᵢ:
$${\begin{matrix}{\hat{τ}}_{i} & {( {Φ}^{T} )}^{- 1} & {}^{T} {D}_{i} = [ {\hat{θ}}_{i 1}^{T} ,\end{matrix} {\hat{θ}}_{i 2}^{T} , … , {\hat{θ}}_{i n}^{T} ]}^{T}$$
thereby obtaining an estimated value \hat{θ}ᵢⱼ of the coefficient θᵢⱼ to be optimized of element Kᵢⱼ(z) in the i-th row and the j-th column in the dynamic decoupling controller K(z), thus realizing dynamic decoupling control.

2. The dynamic decoupling control method according to claim 1, wherein the expected diagonal model M is in the following form:
$$M = [ \begin{matrix}{M}_{1} & & & \\ & {M}_{2} & & \\ & & ⋱ & \\ & & & {M}_{n}\end{matrix} ]$$
wherein a diagonal element Mᵢ represents an expected model of the i-th degree of freedom, in the following form:
$${M}_{i} = \frac{1}{{h}_{i} {s}^{2}} \cdot \frac{1}{{τ}_{i} + 1} , i = \{ 1 , 2 , … , n \}$$
wherein hᵢ represents an inertia coefficient for an i-th degree of freedom, and s represents a Laplace operator, and τᵢ represents a time constant of a time delay in the system.

3. The dynamic decoupling control method according to claim 2, wherein the filter L is in the following form:
$$L = \frac{1}{{( {k}_{s} s + 1 )}^{2}}$$
wherein kₛ represents a time constant, kₛ=0.01.
